(19) United States
(12) Patent Application Publication
(10) Pub. No.: US 2011/0281088 A1
(43) Pub. Date: Nov. 17, 2011

(54) MOISTURE ABSORPTIVE AND PERSPIRATORY CLOTH STRUCTURE

(75) Inventor: Shuo Yen Liao, Panchiao City (TW)

(73) Assignee: Swap Loop Technology Company Limited, Panchiao City (TW)

(21) Appl. No.: 12/781,220

(22) Filed: May 17, 2010

(51) Int. Cl. B32B 3/10; B32B 5/02

(52) U.S. Cl. 428/197; 428/196

(57) ABSTRACT

A moisture absorptive and perspiratory cloth structure comprising a cloth substrate comprised of a fabric being made from a moisture absorbent fiber and a moisture or water repelling layer applied to a surface of the cloth substrate. The moisture or water repelling layer comprising a water repelling agent and having patterns formed of or configured with hollow lines. The moisture repelling layer on the cloth substrate has moisture repelling capability and the patterns formed with the hollow lines in intervals have better exhaust and breathability effects. The cloth substrate being made of a fabric having good water absorption so that it can be broadly used on all kinds of articles including but not limited to clothing.

### FIELD OF THE INVENTION

The present invention relates to a cloth structure, more particularly to a moisture absorptive and perspiratory cloth structure having better exhaust, breathability, and perspiratory effects.

### BACKGROUND OF THE INVENTION

Because the moisture absorption and fast drying capabilities of a fabric influence the comfort of a human's skin while being covered with clothes, clothes with better moisture absorption and fast drying capabilities allow the skin to feel more crisp and comfortable. However, regardless of whether it is natural fiber or synthetic fiber, it is very difficult to have both moisture absorption and fast drying capabilities.

There are many kinds of fabrics present in the market, such as fabrics made from profile fibre, hollow microporous fibre, multilayer fabric, fabrics after hydrophile agent process and fiber surface modification, or fabrics utilizing the strong hydratation of natural fibers to absorb sweat thereto, changing the properties such as water absorption, removing and releasing of moisture from fabrics through a fabric structure design or fiber modification, thereby removing water or sweat absorbed by a fabric to the surface thereof for release so as to enable the fabric to be dried quickly.

Clothing worn for sports, exercise or outdoor leisure activities is more likely to become wet and to influence a person's wearing comfort. For example, clothing can become soaked with morning dew during outdoor exercise or sports, clothing can absorb rain during outdoor activities and during inclement weather, clothing can be splashed by water accumulated on a road, or clothing can be spilled upon such as by soup or drink accidentally.

To solve the problems mentioned above, water repellants, oil repellants, or a combination thereof are processed or treated on the surfaces of fabrics to provide them with proper water and/or oil repellency so as to prevent them from being wetted by liquids such as dew, rain, accumulated water, soup, drink or the like, effectively to be in contact with human skin through the absorption of clothes, enabling the wearing comfort to be maintained. Taiwan Patent No. 096215960 discusses spreading a water repelling layer with one layer of water repelling agent on at least one surface of a gas permeable cloth substrate, and another surface of the cloth substrate opposite to the water repelling layer is configured with a water absorbing layer. But, forming a water repelling layer and a water absorbing layer respectively on the two opposite surfaces of the cloth substrate causes manufacturing procedures to be repetitive and tedious and increases the production cost of the fabric. Moreover, a repelling agent that is used to spread on the surface of the cloth substrate uniformly, will then permeate into the small openings of the yarn and the fiber of the cloth substrate to form a water repelling layer. Although it allows the cloth to have water or oil repellency, it causes bad gas permeation of the fabric and the moisture such as sweat absorbed by the water absorbing layer cannot be expelled from the repelling layer at the surface of the cloth at all because the small openings of the yarn and the fiber are blocked by the water repelling agent. To the contrary, the yarn and the fibers thereof must have larger openings if it is allowed to have gas permeation, and the water or oil repellence will not work by doing so.

Thus, there is a need for a cloth structure having better exhaust, breathability and perspiratory effects.

### SUMMARY OF THE INVENTION

The present invention is directed to a moisture absorptive and perspiratory cloth structure. The cloth structure comprises a cloth substrate and a moisture repelling layer. The cloth substrate is comprised of a fabric made from a moisture absorbent fiber. The moisture repelling layer comprises a moisture repelling agent for repelling moisture such as water and further comprises a pattern or a plurality of patterns. In an aspect of the present invention, the patterns are formed of or configured with hollow lines. The moisture repelling layer is applied on a surface of the cloth substrate. The cloth structure of the present invention allows a surface of the cloth to have moisture absorption, and another surface thereof to have moisture repellence so as to achieve good breathability, perspiratory, and moisture draining effects and so as to have good wearing comfort while being worn in every kind of climate and circumstance.

In one aspect of the present invention, a water absorptive and perspiratory cloth structure is provided. The cloth structure comprises a cloth substrate and a water repelling layer. The water repelling layer comprises a water repelling agent for use to repel water. The water repelling layer has a pattern or a plurality of patterns. In another aspect of the present invention, the patterns are formed of or configured with hollow lines. Because the cloth substrate is a good water absorptive fabric, one surface of the substrate cloth having been applied with a water repelling layer comprising a water repelling agent and patterns formed of or configured with hollow lines, allows the fabric to acquire water drainage. Furthermore, the hollow lines with tiny intervals formed or configured into patterns of the water repelling layer allow a human body's water content or sweat to be removed to the absorbent fibers of the cloth substrate easily through the hollow lines, and the fabric absorbing the sweat is dried through moisture release, capable of achieving good breathability and perspiration and maintaining good wearing comfort while being worn in every kind of climate and circumstance.

Another aspect of the present invention is to provide a moisture absorptive and perspiratory cloth structure having only one water repelling layer comprising a water repelling agent and having patterns formed with hollow lines in tiny intervals that is applied on the surface of a cloth substrate, thereby simplifying manufacturing procedures, increasing the production efficiency and reducing the production cost.

Still another aspect of the present invention is to provide a moisture absorptive and perspiratory cloth structure further comprising a cross-linking layer. The cross-linking layer comprises a cross-linking agent. The cross-linking layer is adjacent or next to the water repelling layer. The cross-linking layer comprising the cross-linking agent combines the bottom or bottoms of a pattern or patterns with the surface of a cloth substrate by cross-linking, thereby adhering the surface of the cloth substrate to the water repelling layer closely so as to have fastness to water washing and increase the ruggedness of the water repelling layer of the cloth.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

The present invention can be more fully understood by reference to the following description and accompanying drawings, in which:

FIG. 1 is a schematic view, showing a moisture absorptive and perspiratory cloth structure according to the present invention;

FIG. 2 is a schematic view, showing a cloth substrate of a moisture absorptive and perspiratory cloth according to the present invention;

FIG. 3 is a partial cross sectional view, showing a moisture absorptive and perspiratory cloth structure according to the present invention;

FIG. 4 is a partial cross sectional view, showing a moisture absorptive and perspiratory cloth structure according to the present invention; and

FIG. 5 is a partial cross sectional view, showing a moisture absorptive and perspiratory cloth structure according to the present invention.

### DETAILED DESCRIPTION OF THE INVENTION

The following detailed description of the embodiment(s) is merely exemplary in nature and is in no way intended to limit the invention, its application, or uses.

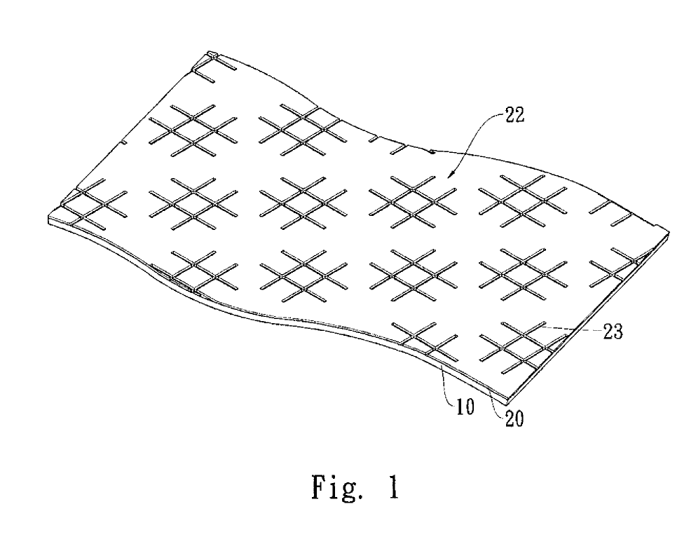

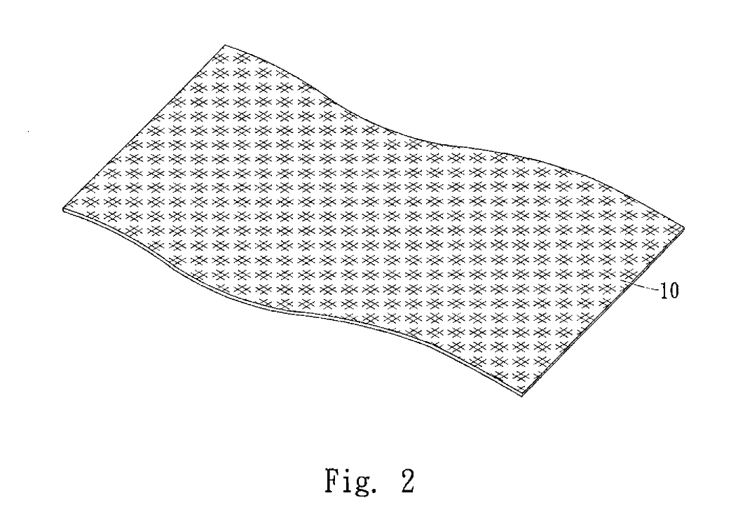

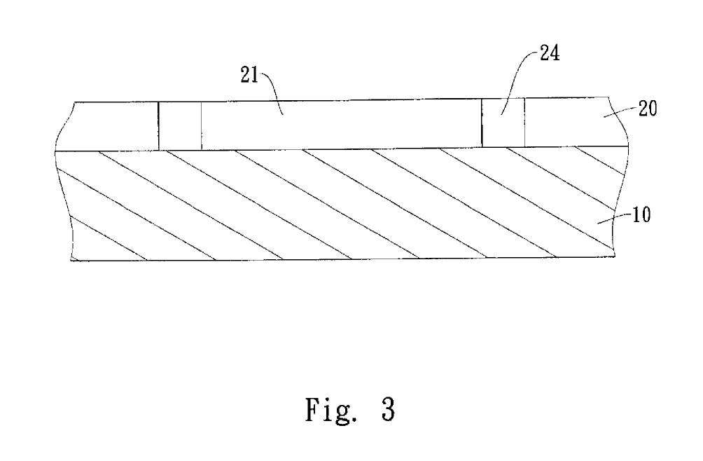

Referring to FIGS. 1 to 3, a moisture absorptive and perspiratory cloth structure comprising a cloth substrate 10 and a water repelling layer 20 is shown.

The cloth substrate 10 is a knit or woven fabric made from a natural fiber, synthetic fiber, or a blend or combination thereof. The fiber may be naturally moisture absorbent or is treated or modified to be moisture absorbent. A fiber surface modifier is, for example, added in a processing fluid at the same time during a wet finish or dye bleaching process of the fabric, where the fiber surface modifier is a moisture absorbent. Possible moisture absorbents include, but are not limited to, sodium polyacrylate, polyoxyethylene ether, non-ionic surfactant, polymeric emulsifier or the like. The cloth substrate treated or modified with a moisture absorbent in the fibers of the fabric allows the fabric to have good water absorption as compared to the same cloth substrate without the moisture absorbent.

The water repelling layer 20 is a moisture or water draining layer comprising a water repelling agent 21. The water repelling agent 21 is a chemical compound containing a nonmetal. The water repelling layer is configured with a pattern or a plurality of patterns 22, such that the water repelling agent 21 is caused to permeate into the fibers on the surface of the cloth substrate 10. Furthermore, hollow lines 23 are formed or configured into the patterns 22, and the hollow lines 23 are in intervals 24 of 0.1 mm to 1.5 mm.

As mentioned above, when a water repelling layer 20 comprising water repelling agent 21 and further comprising patterns 22 formed or configured with hollow lines 23 is applied on the surface of the cloth substrate 10, because the cloth substrate 10 is a natural fiber or a surface modified water absorptive fiber, and because the water repelling layer 20 comprising the water repelling agent 21 is applied on one surface of the cloth substrate 10, the cloth structure has water drainage. Because the hollow lines 23 are configured into the patterns 22 of the water repelling layer 20, the moisture content or sweat of a human body, for example, is removed to the water absorptive fibers of the cloth substrate 10 easily through the hollow lines 23, and the moisture or sweat absorbed by the fabric can then be released to enable the fabric to be dried quickly so that the fabric can be worn in every kind of climate and circumstance without losing the wearing comfort.

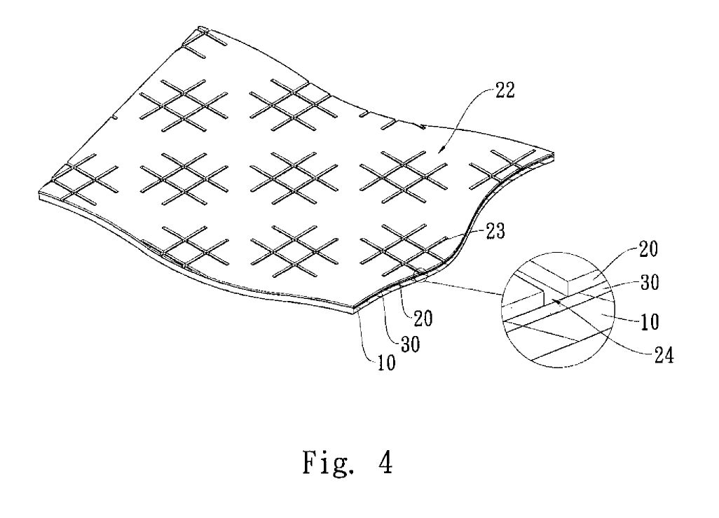

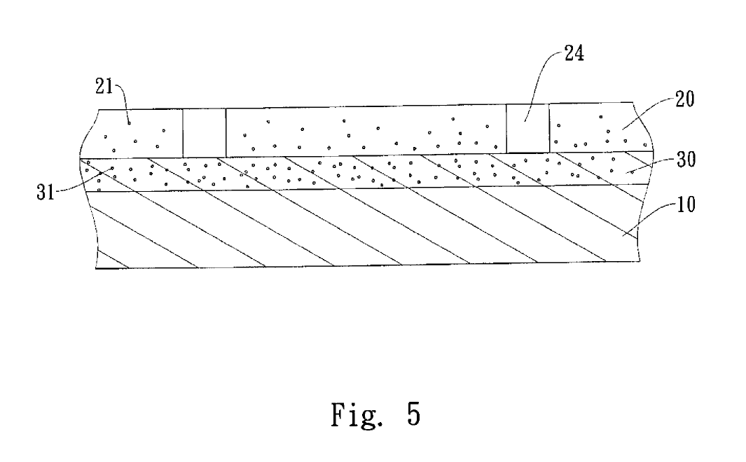

Referring to FIGS. 4 and 5, a moisture absorptive and perspiratory cloth structure of another preferred embodiment according to the present invention is shown that includes a cloth substrate 10 and a water repelling layer 20.

The cloth substrate 10 is a knit or woven fabric made from a natural fiber, synthetic fiber, or a blend or combination thereof. The fiber is naturally moisture absorbent or is treated to be modified to be moisture absorbent. A fiber surface modifier (e.g. a moisture absorbent containing sodium polyacrylate) is added in a processing fluid at the same time during a wet finish or dye bleaching process of the fabric; the fiber surface modifier such as the moisture absorbent permeates in the fibers of the fabric allowing the fabric to have a good water absorption.

As shown in FIGS. 4 and 5, the water repelling layer 20 is a water draining layer comprising a water repelling agent 21. A cross-linking layer 30 comprises a cross-linking agent 31. The water repelling layer 20 is configured with a plurality of patterns 22, such that the water repelling agent 21 is caused to permeate into the fibers on the surface of the cloth substrate 10. The water repelling agent 21 is a chemical compound containing a nonmetal. Furthermore, hollow lines 23 are configured into patterns 22, and the lines 23 are in intervals 24 of 0.1 mm to 1.5 mm.

As mentioned above, the cross-linking agent 31 is used to form cross-linking layer 30 that is arranged on the water repelling layer 20; the cross-linking agent 31 of the cross-linking layer 30 enables cross-linking to occur between the bottoms of the patterns (not shown) and the surface of the cloth substrate 10.

As mentioned above, the cross-linking agent 31 is used to form cross-linking layer 30 that is arranged on the water repelling layer 20 enabling cross-linking between the bottoms of the patterns (not shown) and the surface of the cloth substrate 10; it not only allows a cloth to have good breathability, perspiratory and water repellence effects, but also adheres the water repelling layer 20 to the cloth substrate 10 closely, thereby having fastness to water washing and increasing the ruggedness of the water repelling layer 20 of the cloth.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A moisture absorptive and perspiratory cloth structure, comprising:
a cloth substrate comprised of a fabric made from a moisture absorbent fiber; and
a moisture repelling layer applied to a surface of the cloth substrate, the moisture repelling layer comprising a moisture repelling agent and having a pattern or a plurality of patterns.

2. The moisture absorptive and perspiratory cloth structure according to claim 1, wherein the moisture repelling agent is a water repelling agent.

3. The moisture absorptive and perspiratory cloth structure according to claim 1, wherein the moisture absorbent fiber of the cloth substrate comprises a moisture absorbent.

4. The moisture absorptive and perspiratory cloth structure according to claim 1, wherein the moisture absorbent fiber of the cloth substrate is naturally moisture absorbent.

5. The moisture absorptive and perspiratory cloth structure according to claim 3, wherein said moisture absorbent is sodium polyacrylate, polyoxyethylene ether, a non-ionic surfactant, a polymeric emulsifier, or a combination thereof.

6. The moisture absorptive and perspiratory cloth structure according to claim 1, wherein the patterns are formed of or configured with hollow lines.

7. The moisture absorptive and perspiratory cloth structure according to claim 6, wherein the hollow lines are in intervals of 0.1 mm to 1.5 mm.

8. The moisture absorptive and perspiratory cloth structure according to claim 1, wherein the moisture repelling agent is a chemical comprising a nonmetal.

9. The moisture absorptive and perspiratory cloth structure according to claim 1, wherein the cloth substrate is a knit or woven fabric.

10. A moisture absorptive and perspiratory cloth structure, comprising:
a cloth substrate comprised of a fabric made from a moisture absorbent fiber;
a cross-linking layer; and
a moisture repelling layer comprising a moisture repelling agent and having a pattern or a plurality of patterns.

11. The moisture absorptive and perspiratory cloth structure according to claim 10, wherein the cross-linking layer comprises a cross-linking agent.

12. The moisture absorptive and perspiratory cloth structure according to claim 10, wherein the cross-linking layer is arranged on the moisture repelling layer.

13. The moisture absorptive and perspiratory cloth structure according to claim 10, wherein the cross-linking layer provides cross-linking between a bottom of the pattern or the plurality of patterns of the moisture repelling layer and the cloth substrate.

14. The moisture absorptive and perspiratory cloth structure according to claim 10, wherein the pattern is or the plurality of patterns are formed or configured with hollow lines.

15. The moisture absorptive and perspiratory cloth structure according to claim 14, wherein the hollow lines are in intervals of 0.1 mm to 1.5 mm.

16. The moisture absorptive and perspiratory cloth structure according to claim 10, wherein the water repelling agent is a chemical comprising a nonmetal.

17. The moisture absorptive and perspiratory cloth structure according to claim 10, wherein the cloth substrate is a knit or woven fabric.

18. The moisture absorptive and perspiratory cloth structure according to claim 10, wherein the moisture repelling agent is a water repelling agent.

19. A moisture absorptive and perspiratory cloth structure, comprising:
a cloth substrate comprised of a fabric made from a moisture absorbent fiber; and
a single moisture repelling layer applied to a surface of the cloth substrate, the moisture repelling layer comprising a moisture repelling agent and having a pattern or a plurality of patterns.

20. The moisture absorptive and perspiratory cloth structure according to claim 19, wherein the pattern is or the plurality of patterns are formed or configured with hollow lines.
